(19) United States
(12) Patent Application Publication
(10) Pub. No.: US 2006/0085847 A1
(43) Pub. Date: Apr. 20, 2006

(54) Locking system and locking method

(75) Inventors: Yoshihiro Ikeuchi, Tokyo (JP); Toru Tanaka, Kawagoe-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: CITIZEN WATCH CO., LTD.

(21) Appl. No.: 11/249,957

(22) Filed: Oct. 14, 2005

(30) Foreign Application Priority Data
Oct. 15, 2004 (JP) 2004-301488
Sep. 28, 2005 (JP) 2005-282607

(51) Int. Cl. H04L 9/32

(52) U.S. Cl. 726/6

(57) ABSTRACT

According to the present invention, when a computer has been locked, a password for unlocking the computer can be acquired while maintaining a high security level. The invention provides a locking system and a locking method for the same, the locking system comprising a portable device, which includes first storage means (103) for storing a first authentication code, a first control section (101) for generating a rolling value and for creating an ID code by using the rolling value and the first authentication code, and transmitting means (105) for transmitting the ID code, and a computer, which includes second storage means (203) for storing a second authentication code, receiving means (254) for receiving the ID code, and second control means (201) for recovering the rolling value and the first authentication code from the ID code, creating a spare code by using the second authentication code and the recovered rolling value, and storing the spare code.

### FIELD OF THE INVENTION

The present invention relates to a locking system comprising an identification information transmitter such as a portable device and an apparatus to be locked, such as a computer, and a method for use of such a system.

### BACKGROUND OF THE INVENTION

There are cases where a user inputs highly sensitive information or creates a document containing such information by using a PC (Personal Computer). In such cases, when the user leaves the PC, measures must be taken to prevent the data stored in the PC from being viewed, downloaded, altered, or erased by a third party without the user's permission.

To address this, it is known to provide a security system wherein user identification information is transmitted from a portable device carried by the user, with provisions made to permit the use of the PC only when the user identification information received by the PC matches preregistered information (for example, Patent Document 1).

Further, in a receiving device that unlocks a vehicle by receiving a code from a portable device carried by the user, it is known to provide a system wherein an unlock code for unlocking the vehicle next time is automatically changed at the receiving device side (for example, Patent Document 2).

Such systems, however, have had the problem that in the event of failure of the user's portable device, the user cannot continue to use the PC, etc.

Here, provisions may be made so that, in the event of failure of the portable device, the PC can be unlocked for use by entering a user password, etc.; however, if the user forgets the user password, the user has to ask the manufacturer to repair the portable device. Asking for repair from the manufacturer has the problem that it takes time and is expense.

Patent Document 1: JP-A-2000-99187 (pp. 5-6, FIG. 2)

Patent Document 2: JP-A-S62-23847 (page 2)

### SUMMARY OF THE INVENTION

Accordingly, an object of the present invention is to provide a locking system that can solve the above problems.

Another object of the present invention is to provide a locking system wherein, when a computer has been locked, a password for unlocking the computer can be acquired while maintaining a high security level.

As further object of the present invention is provide a locking system wherein, when a computer has been locked, a password for unlocking the computer can be acquired even in a situation where not only is the computer unable to receive an ID code from a portable device but user password is also lost.

A locking system according to the present invention comprises,

a portable device, which comprises first storage means for storing a first authentication code, a first control section for generating a rolling value and for creating an ID code by using the rolling value and the first authentication code, and transmitting means for transmitting the ID code, and

a computer, which comprises second storage means for storing a second authentication code, receiving means for receiving the ID code, and second control means for recovering the rolling value and the first authentication code from the ID code, creating a spare code by using the second authentication code and the recovered rolling value, and storing the spare code, wherein

the second control means unlocks the computer when the recovered first authentication code matches the second authentication code, but locks the computer when the recovered first authentication code does not match the second authentication code; when the computer has been locked, the second control means unlocks the computer when a code that matches the spare code is input; and the second control means creates a rolling code using a public code and the rolling value in order to acquire the code that matches the spare code from a computer management server.

Preferably, the locking system according to the present invention further comprises a computer management server which comprises a database constructed by associating each public code with a corresponding authentication code, receiving means for receiving the rolling code, and third control means for recovering the public code and the rolling value from the rolling code, searching the database to retrieve the corresponding authentication code associated with the recovered public code, and creating a second spare code from the recovered rolling value and the retrieved authentication code. This enables the user to acquire a safe spare code.

Preferably, in the locking system according to the present invention, the portable device further comprises encrypting means for encrypting the ID code, and the computer further includes decrypting means for decrypting the ID code received in encrypted form. Here, encryption serves to further enhance the security level.

Preferably, in the locking system according to the present invention, the computer further comprises encrypting means for encrypting the rolling code and decrypting means for decrypting the spare code input thereto, and the computer management server further includes decrypting means for decrypting the rolling code and encrypting means for encrypting the second spare code. Here, encryption serves to further enhance the security level.

Preferably, in the locking system according to the present invention, the second control means creates the spare code by using the rolling value initially received from the portable device.

Preferably, in the locking system according to the present invention, the computer further comprises storing means for storing the most up-to-date rolling value received from the portable device, and the second control means performs control so that the computer is locked when the currently acquired rolling value does not change from the most up-to-date rolling value stored in the storage means. For example, when the rolling code is used which is incremented by one each time a transmission is made from the portable device, the security level can be further enhanced.

Preferably, in the locking system according to the present invention, the second control means sets a user password and stores the user password, and when the computer has been locked, the second control means unlocks the computer when a code that matches the user password is input. In this way, the computer can also be unlocked by the user password.

A locking method according to the present invention comprises the steps of receiving an ID code that a portable device having a public code created by using a rolling value generated by the portable device and a first authentication code prestored therein, recovering the rolling value and the first authentication code from the ID code, creating a first spare code from the rolling value recovered from the ID code and a second authentication code prestored in a computer, and storing the first spare code, locking the computer when the authentication code recovered from the ID code does not match the second authentication code; creating a rolling code from the public code and the rolling value recovered from the ID code, receiving a spare code that a management server for managing the computer created from the rolling value recovered from the rolling code and the second authentication code retrieved by conducting a search based on the public code recovered from the rolling code, and unlocking the computer when the received spare code matches the first spare code.

An apparatus to be locked according to the present invention comprises a control section performs a first authentication process using first identification information received from an identification information transmitter and a second authentication process using second identification information other than the received first identification information, controls the apparatus, to be unlocked when authentication is successfully done in the first or second authentication process, and creates spare identification information with which the second identification information is compared in the second authentication process. In this configuration, at least two authentication processes are performed and, when authentication is successfully done in either one of the processes, the locked apparatus such as a computer is unlocked; here, the spare identification information to be used in the second authentication process is created in the apparatus to be locked.

Preferably, in the locking system according to the present invention, the control section creates the spare identification information by using the received first identification information.

Preferably, in the locking system according to the present invention, the first identification information includes variable identification information which varies each time the first identification information is transmitted from the identification information transmitter, and the control section creates the spare identification information by using the variable identification information. Here, the apparatus to be locked is configured to creates the spare identification information by using the variable identification information such as a rolling value.

Preferably, in the locking system according to the present invention, the first identification information includes unique identification information unique to the identification information transmitter and variable identification information which varies each time the first identification information is transmitted from the identification information transmitter, and the control section creates the spare identification information by using the unique identification information and the variable identification information.

Preferably, in the locking system according to the present invention, the unique identification information includes first fixed identification information and second fixed identification information, and the first authentication process is a process in which, when the first fixed identification information matches data stored in the locked apparatus, then a determination is made as to whether the second fixed identification information and the variable identification information satisfy a prescribed condition. That is, the system is configured so that when the first fixed identification information such as a public code, for example, matches the data stored in the locked apparatus such as a computer, then a determination is made as to whether the second fixed identification information such as a first identification code and the variable identification information such as a rolling value satisfy a prescribed condition.

According to the present invention, the computer can be unlocked by acquiring the second authentication code while maintaining a high security level.

Furthermore, according to the present invention, even when the first identification information becomes unable to be received from the identification information transmitter such as a portable device, the locked apparatus such as a computer can be unlocked by using the spare identification information created by the apparatus.

### BRIEF DESCRIPTION OF THE DRAWINGS

These and other features and advantages of the present invention will be better understood by reading the following detailed description, taken together with the drawings wherein:

FIG. 1 is a diagram for explaining an outline of a locking system according to the present invention:

FIG. 2 is a block diagram showing one example of a portable device and a PC terminal used in the locking system according to the present invention;

FIG. 3 is a diagram showing one example of a control flow in the locking system according to the present invention;

FIG. 4 is a diagram showing one example of an authentication process control flow;

FIG. 5 is a diagram showing one example of a control flow for acquiring a spare code;

FIG. 6 is a diagram showing one example of a display screen that appears when the computer is locked;

FIGS. 7(a) to (f) are diagrams each showing the timing of data transmission between the portable device and the PC terminal;

FIG. 8 is a diagram showing one example of a control flow for controlling the data transmission timing such as shown in FIGS. 7(c) and 7(d);

FIG. 9 is a diagram showing one example of a control flow for controlling the data transmission timing such as shown in FIGS. 7(e) and 7(f);

FIG. 10 is a diagram showing another example of the control flow in the locking system according to the present invention;

FIG. 11 is a diagram showing an output example of an acceleration sensor;

FIG. 12 is a diagram showing still another example of the control flow in the locking system according to the present invention; and

FIG. 13 is a diagram showing yet another example of the control flow in the locking system according to the present invention.

### DETAILED DESCRIPTION OF THE PREFERRED EMBODIMENT

A locking system and a locking method according to the present invention will be described below with reference to the drawings.

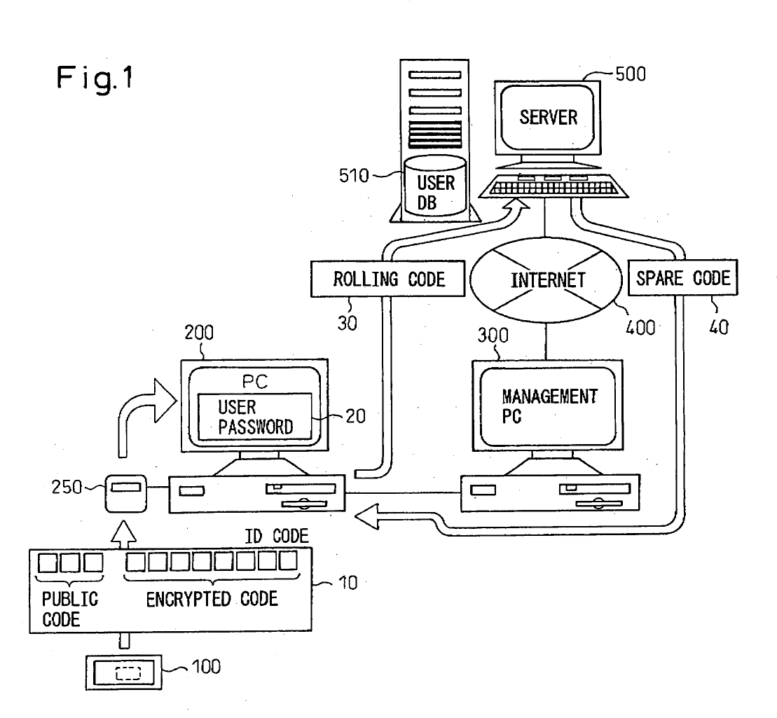

FIG. 1 is a diagram showing the general configuration of the locking system according to the present invention.

A portable device 100 transmits an ID code 10 at predetermined intervals of time (for example, every two seconds). The ID code 10 is made up of a public ID code and an encrypted code. A base 250 connected to a PC terminal 200 receives the ID code 10. If the public ID code included in the received ID code matches the public ID code preregistered in the base 250, the base 250 stores the encrypted code included in the ID code 10 into a storage section provided within the base 250.

The portable device 100 is designed in the form of a badge so that the user can always wear it on him. However, the portable device 100 may be designed in the form of a card of business card size that can be hung from the user's neck or in the form of a wristwatch, or may be incorporated into an existing information terminal or the like such as a mobile telephone, a PDA, or a small-size PC terminal, and its size, weight, shape, etc. are not specifically limited.

The PC terminal 200 acquires the encrypted code stored in the base 250 at predetermined intervals of time. Further, the PC terminal 200 performs authentication of the portable device 100 by recovering a first authentication ID code and a rolling value from the encrypted code in accordance with a method to be described later. When the portable device 100 is authenticated, the use of the PC terminal 200 is permitted.

If the ID code 10 becomes unable to be received because of failure and/or battery exhaustion of the portable device 100, the PC terminal 200 can no longer authenticate the portable device 100, and the use of the PC terminal 200 is thus prohibited. That is, inputs from the operating means (keyboard, mouse, etc.) attached to the PC terminal 200 are invalidated (the PC terminal is locked). This causes great inconvenience to the user because the user cannot use the PC terminal 200 until the portable device 100 is repaired or the battery is replaced. In view of this, the locking system of the present invention provides two alternative methods that permit the use of the PC terminal 200 in case of emergency.

The first method is to use a user password 20 preset by the user. Even when the PC terminal 200 has been locked because of failure and/or battery exhaustion of the portable device 100, the user can log on to the PC terminal 200 (unlock the PC terminal) by entering the user password 20.

The second method is to use a spare code that is reserved in case the user password 20 is lost. A management PC 300 which manages the PC terminal 200 is connected to the PC terminal 200 via a LAN network. The management PC 300 accesses a server 500 via the Internet 400, and uploads a rolling code 30. The server 500 creates a spare code 40 from the rolling code 30 by using a user DB 510 prestored therein. The management PC 300 downloads the spare code from the server 400 and transmits it to the PC terminal 200. The PC terminal 200 is unlocked by using the spare code 40. The details of the second method will be described later.

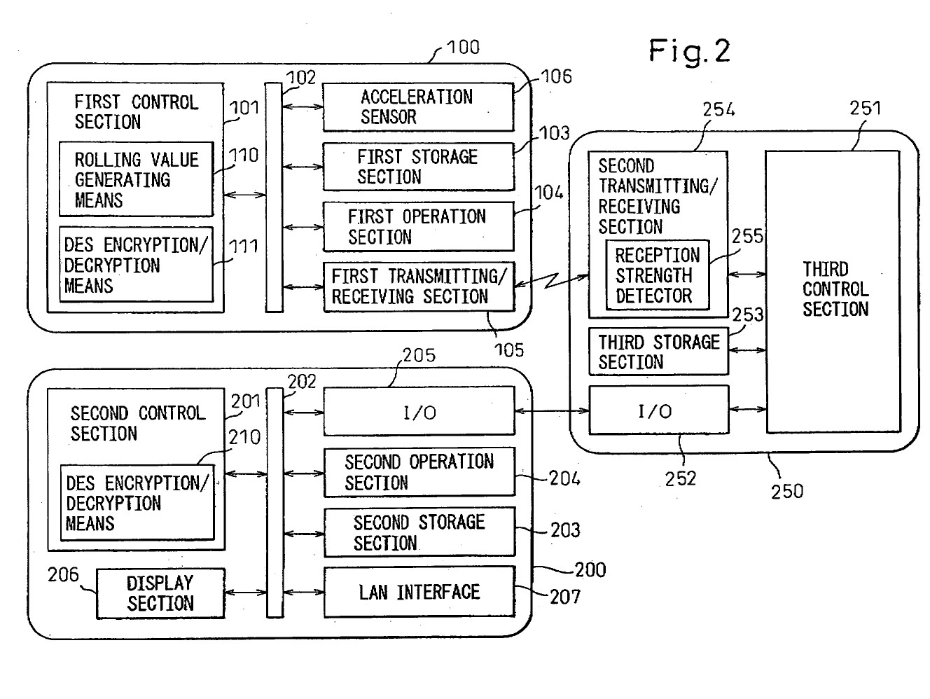

FIG. 2 is a block diagram showing the general configuration of the portable device 100, PC terminal 200, and base 250.

The portable device 100 comprises: a control section 101; a bus 102; a first storage section 103 constructed from various kinds of storage media connected via the bus 102 to the first control section 101; a first operation section 104 comprising buttons, etc.: a first transmitting/receiving section 105 for such purposes as wireless transmission of the ID code; an acceleration sensor 106; and a power supply circuit (not shown) containing a battery, etc.

The first control section 101 comprises a CPU core, a ROM (Read Only Memory) for storing a program, etc., a RAM (Random Access Memory) for providing a work area, and peripheral circuitry. The first control section 101 further includes a rolling value generating means 110 for generating a rolling value and a DES encryption/decryption means 111 for performing encryption and decryption of various codes. The first transmitting/receiving section 105 is a wireless transmitter having only a single transmission channel (transmitting frequency).

The rolling value generating means 110 generates a 5-byte rolling value which is incremented by one for each transmission of the ID code and which rolls back to the initial value when five bytes are exceeded. However, the rolling value is not limited to this particular example, but use may be made of data that is decremented one at a time or data that is varied in accordance with a prescribed rule. Further, data that does not roll back to the initial value may also be used as the rolling value.

The PC terminal 200 comprises: a second control section 201; a bus 202; a second storage section 203 constructed from a storage medium such as a hard disk connected via the bus 202 to the second control section 201; a second operation section 204 comprising a keyboard, a mouse, etc.; an I/O 205 for connecting to the base 250; a display section 206 constructed from a liquid crystal or CRT display; and a LAN interface 207 for connecting to the management computer via a LAN cable.

The second control section 201 comprises a CPU core, a ROM for storing a program, etc., a RAM for providing a work area, and peripheral circuitry, and includes a DES encryption/decryption means 210 for performing encryption and decryption of various codes.

The base 250 comprises: a third control section 251; an I/O 252 for connecting to the PC terminal 200; a third storage section 253 constructed from various kinds of recording media and recording devices; and a second transmitting/receiving section 254 for receiving the ID code from the portable device 100. The third control section 251 comprises a CPU core, a ROM for storing a program, etc., a RAM for providing a work area, and peripheral circuitry. The second transmitting/receiving section 254 is constructed by including a reception strength detector 255 for detecting the reception strength of the received ID code.

In the present embodiment, the base 250 for receiving the ID code 10 from the portable device 100 is provided and connected to the PC terminal 200, but the function of the base 250 may be incorporated into the PC terminal 200 itself.

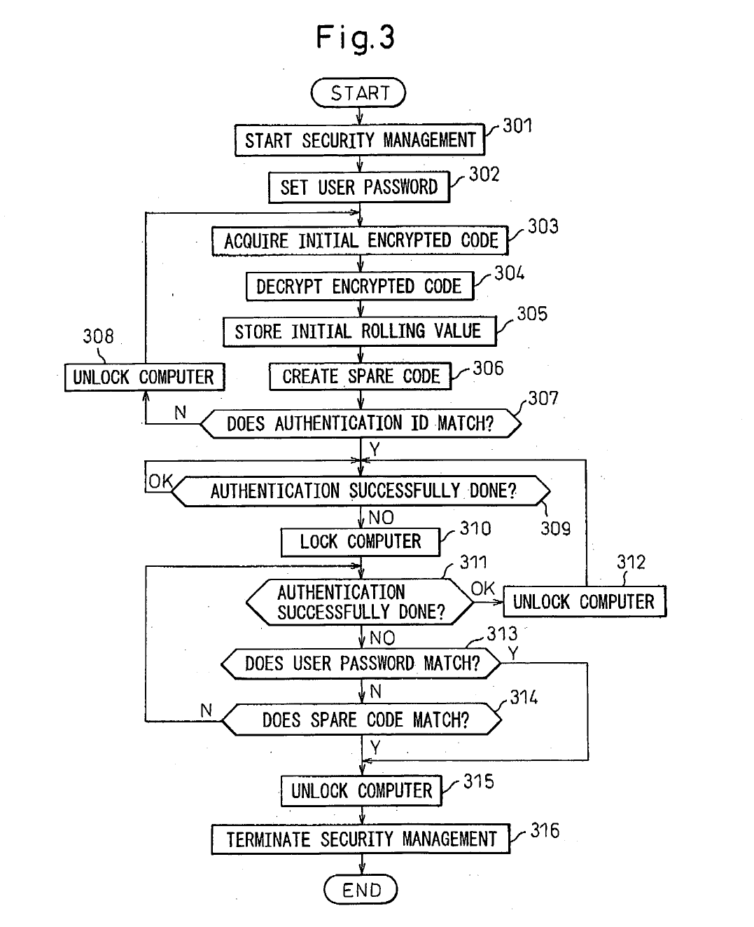

FIG. 3 is a diagram showing one example of the control flow of the locking system according to the present invention.

The control flow shown in FIG. 3 is constructed to be executed primarily by the second control section 201 in accordance with a locking system application program preinstalled in the second storage section 203 of the PC terminal 200.

The first control section 101 of the portable device 100 is preprogrammed to create the ID code and transmit it from the first transmitting/receiving section 105 at predetermined intervals of time (for example, every two seconds). Here, the first authentication ID code (for example, 3-byte data) stored in the first storage section 103 and the rolling value (for example, 5-byte numeric data) generated by the rolling value generating means 110 are acquired, and the encrypted data (for example, 8-byte data) is created by encrypting the above two kinds of data by the DES encryption/decryption means 111. Further, the first control section 101 of the portable device 100 creates the ID code (for example, 11-byte data) by combining the encrypted data with the public ID code unique to the portable device 100 (the public ID code is, for example, 3-byte data and indicated on the rear panel of the portable device 100).

The user DB 510, a database constructed by associating each public ID code with a corresponding authentication ID code, is prestored in the server 500. Preferably, the server 500 is operated by the manufacturer, dealer, or agent that manufactures or sells the computer locking system of the present invention.

First, the locking system application program is started on the PC terminal 200, and prescribed operations for initiating security management are performed from the display section 206 of the PC terminal 200 (S301). The prescribed operations include the operation for bringing the portable device 100 close to the base 250, thereby causing the base 250 to receive the ID code transmitted from the portable device 100 and storing the first authentication code included in the ID code into the second storage section 203 of the PC terminal 200. With this operation, the first authentication code held in the portable device 100 is stored as the second authentication code in the second storage section 203 of the PC terminal 200.

When the system application program is started, the second authentication ID code for authenticating the corresponding portable device 100 is stored in the second storage section 203. Further, when the system application program is started, the third control section 251 of the base 250 prestores the public ID code of the corresponding portable device 100. As a result, the third control section 251 of the base 250 stores the encrypted code included in the received ID code into the third storage section 253 only when the public ID code included in the received ID code matches the stored public ID code. Here, the third control section 251 is programmed to continue to store only the most up-to-date encrypted code at all times.

Next, the second control section 201 sets the user password (S302). The user of the PC terminal 200 can set the user password 20 by performing prescribed operations from the display section of the PC terminal 200. The second control section 201 stores the thus set user password 20 in the second storage section 203.

Then, the second control section 201 acquires the encrypted code stored in the third storage section 253 of the base 250 (S303), and decrypts the encrypted code by using the DES encryption/decryption means 210 (S304). By decrypting the encrypted code, the first authentication ID code and the initial rolling value can be recovered. The second control section 201 stores the initial rolling value in the second storage section 203 (S305).

Next, the second control section 201 creates the spare code (for example, 8-byte code) made up of the second authentication ID code stored in the second storage section 203 and the initial rolling value recovered in S305, and stores the spare code in the second storage section 203 (S306).

Next, the second control section 201 determines whether the first authentication ID data decrypted in S304 matches the second authentication ID data prestored in the second storage section 203 (S307). If they do not match, inputs from the second operation section 204 of the PC terminal 200 are invalidated, that is, the PC terminal 200 is locked (S308), and the process returns to step S303 to repeat the steps S303 to S307. When the first authentication ID data matches the second authentication ID data, the process proceeds to the next step.

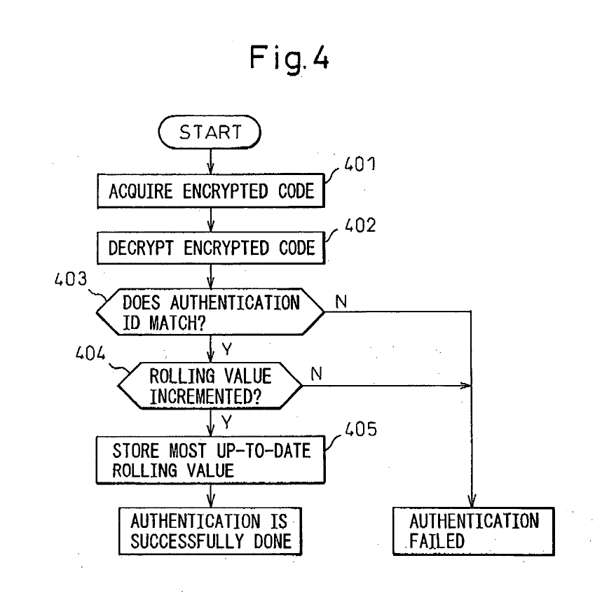

After that, the second control section 201 repeats the usual authentication process (s309) to be described later (refer to FIG. 4). As long as the authentication is successfully done, the usual authentication process (S309) is repeated at predetermined intervals of time (for example, an interval at which the portable device 100 transmits the ID code) while keeping the PC terminal 200 enabled for use. If the authentication fails in the authentication process, the PC terminal 200 is locked (S310).

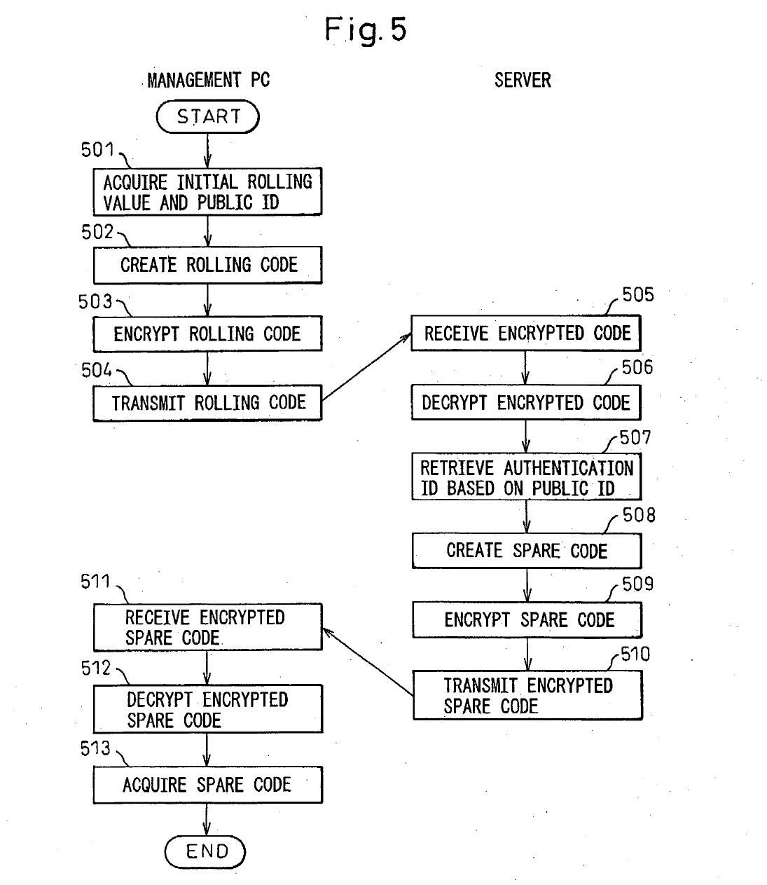

Once the PC terminal 200 has been locked, the PC terminal 200 will not be unlocked for use again, unless one of the following conditions is satisfied: the authentication is successfully done in the subsequent cycle of the usual authentication process (for example, when the wireless communication between the portable terminal 100 and the PC terminal 200 is restored after being temporarily suspended) (S311); the correct user password set in S302 is entered (S313); and the correct spare code to be described later (refer to FIG. 5) is entered (S314). That is, as long as none of these conditions are satisfied, the PC terminal 200 will remain locked, and therefore, cannot be used.

Here, when the authentication is successfully done in the subsequent cycle of the usual authentication process (S311), the PC terminal 200 is unlocked (S312), and the process returns to S309 to continue the security management of the PC terminal 200 as usual; on the other hand, in the case where the correct user password is entered (S313) or where the correct spare code is entered (S314), the security management is terminated (S316) after unlocking the PC terminal 200 (S315).

The reason that the security management is terminated in the above case is that, in the case where the correct user password is entered (S313) or where the correct spare code is entered (S314), it is highly likely that it will take time to restore from the failed state because the authentication failure is presumed to have been caused by the failure, battery exhaustion, etc. of the portable device 100. Accordingly, by not reinitiating the security management (S301), it becomes possible to freely use the PC terminal 200 thereafter. However, the system may be configured to not terminate the security management in the case where the correct user password is entered (S313) or where the correct spare code is entered (S314),

FIG. 4 is a diagram showing one example of the processing flow of the usual authentication process shown in S309 of FIG. 3.

First, the second control section 201 acquires the encrypted code stored in the third storage section 253 of the base 250 (S401), and decrypts the encrypted code by using the DES encryption/decryption means 210 (S402). By decrypting the encrypted code, the authentication ID code and the rolling value can be recovered.

Next, the second control section 201 determines whether the authentication ID data decrypted in S402 matches the second authentication ID data prestored in the second storage section 203 (S403). When they match, it is determined whether the rolling value decrypted in S402 is larger than the previous rolling value (which is stored as the most up-to-date rolling value in the storage section 203) (S404).

If it is determined in S404 that the rolling value decrypted in S402 is larger than the previous rolling value, the rolling value decrypted in S402 is stored as the most up-to-date rolling value in the storage section 203 (S405), and it is determined that the authentication has been done successfully.

If the authentication ID data do not match in S403, or if the rolling value decrypted in S402 is not larger than the previous rolling value in S404, then it is determined that the authentication has failed.

FIG. 5 is a diagram showing one example of the processing flow of the spare code acquisition shown in S314 of FIG. 3.

First, the initial rolling value (see S305 in FIG. 3) stored in the second storage section 203 of the locked PC terminal 200 and the public ID code of the portable device 100 corresponding to the PC terminal 200 are acquired by the management PC 300 connected to the LAN network (S501).

Next, the management PC 300 creates a rolling code (for example, 8-byte data) made up of a null code (for example, three bytes) and the initial rolling value (for example, 5-byte data) (S502). Then, the management PC 300 creates an encrypted rolling code by using its built-in DES encryption/decryption means (S503). Further, the management PC 300 accesses the server 500 by using its built-in network connecting means, and transmits the created rolling code together with the public ID code acquired in S501 (S504). Here, if the null code is used, the rolling code when acquiring the spare code for the second time will become the same as the previous rolling code, posing a security problem. To address this, random numbers may be used instead of the null code.

Upon receiving the encrypted rolling code and the public ID code (S505), the server 500 decrypts the encrypted code by using its built-in DES encryption/decryption means, to recover the null code and the initial rolling value from the encrypted rolling code (S506).

Using the received public ID code, the server 500 searches the user DB 50 to retrieve the authentication ID code corresponding to that public ID code (S507). The server 500 creates the spare code from the thus retrieved authentication ID code and the initial rolling value recovered in S506 (S508). Further, the server 500 encrypts the spare code by using its built-in DES encryption/decryption means (S509), and transmits the encrypted spare code to the management PC 300 (S510).

The management PC 300 receives the encrypted spare code (S511), and decrypts the encrypted spare code by using its built-in DES encryption/decryption means (S512), to acquire the decrypted spare code (S513).

By performing prescribed operations on the management PC 300, the spare code thus acquired is transmitted from the management PC 300 to the PC terminal 200. When the received spare code matches the spare code previously created in the PC terminal 200 (see S306 in FIG. 3), the PC terminal 200 is unlocked for use again (see S314 and S315 in FIG. 3).

In this way, by acquiring the spare code using the initial rolling value from the server 500, the PC terminal 200 can be enabled for use again, even in the event of the operational failure of the portable device 100 or the loss of the user password.

In FIG. 5, the spare code has been obtained from the management PC 300 that manages the PC terminal 200, but when the PC terminal 200 is used as a stand-alone PC, there is no management PC that manages the PC terminal 200. In that case, provisions may be made so that the user can obtain the spare code by directly accessing the server 500.

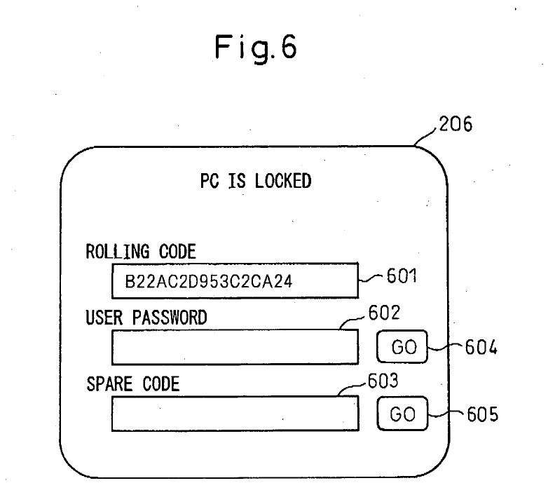

For example, when the PC terminal 200 is locked, a screen showing the encrypted rolling code 601, user password entry box 602, and encrypted spare code entry box 603 is displayed as illustrated in FIG. 6, permitting the entry of only the user password and the spare code. The encrypted rolling code 601 shown in FIG. 6 is one example of the 8-byte encrypted rolling code created in S503 of FIG. 5 by encrypting the rolling code made up of the null code and the initial rolling value.

The user, using a telephone or another PC that he has, contacts an operator at the company that operates the server 500, gives the operator the encrypted rolling code and the public ID code of the portable device 100, and gets the encrypted spare code similar to the one created in S509 of FIG. 5. The user can then type the thus obtained encrypted spare code into the encrypted spare code entry box 603, and effect the entry of the encrypted spare code into the PC terminal 200 by clicking the enter button 605 in FIG. 6. The second control section 201 of the PC terminal 200 recovers the spare code from the entered encrypted spare code by decrypting it using the DES encryption/decryption means 210, and performs control to unlock the PC terminal 200 (see S314 and S315 in FIG. 3) when the entered spare code matches the spare code previously created in the PC terminal 200 (see S306 in FIG. 3).

As described above, even when the computer becomes unable to receive the ID code from the portable device 100 and, on top of that, the user password is lost, the computer can be unlocked by using a spare code having a high security level. Here, as the spare code is created by using the initial rolling value, once the PC terminal 200 is restored to the usual security management operation the spare code can no longer be used. In this sense, the spare code is a one-time password, the advantage being that it cannot be used on a permanent basis.

As described above, in the locking system of the invention, usually the first authentication process is performed using the first identification information (for example, the ID code). However, in such cases as a failure of the portable device 100, the locking system of the invention can perform a second authentication process using second identification information (for example, the spare code created on the server side). In the second authentication process, the second identification information is compared with the spare identification information (the spare code created on the PC terminal side) and, when they match, the PC terminal is unlocked. The first identification information, for example, comprises first fixed identification information (for example, the public code), second fixed identification information (for example, the first authentication ID code), and variable identification information (for example, the rolling value). In the first authentication process, the second fixed identification information is compared, for example, with the data prestored in the PC terminal (for example, the second authentication ID code) and, when they match, the PC terminal is unlocked.

By creating the spare code using the identification information included in the encrypted code transmitted from the portable device 100, the security level equivalent to the usual authentication of the portable device 100 can be achieved even in the authentication with the spare code. In particular, by creating the spare code using the rolling value, the security level of the authentication with the spare code can be further enhanced.

Next, the timing of data transmission between the portable device 100 and the PC terminal 200 will be described.

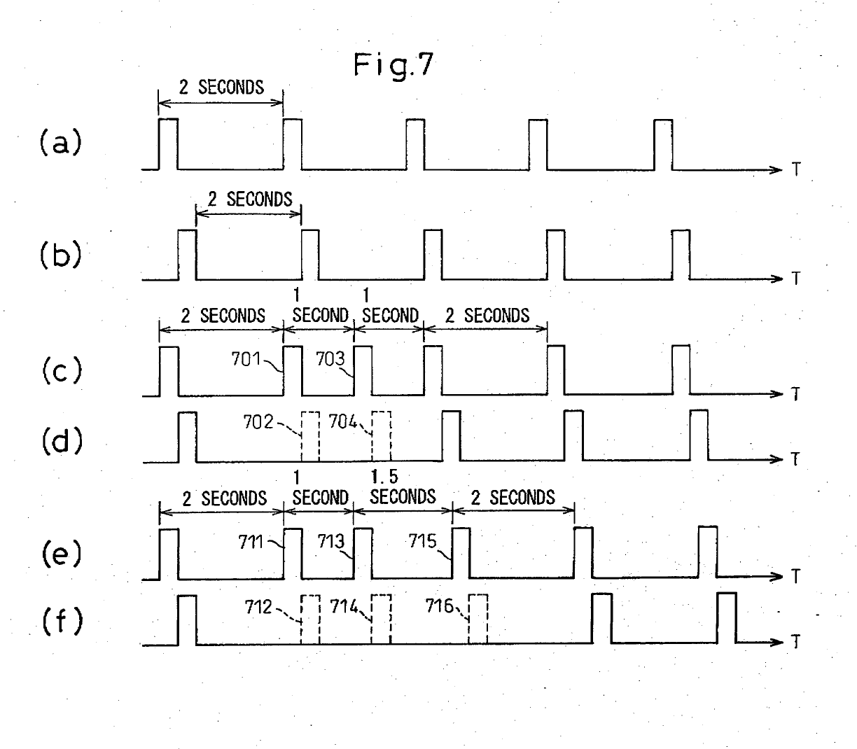

FIG. 7 is a diagram showing examples of the timing of data transmission between the portable device 100 and the PC terminal 200.

FIG. 7(a) shows the transmit timing of the ID code data transmitted from the first transmitting/receiving section of the portable device 100, and FIG. 7(b) shows the transmit timing of the ACK signal that the base 250 connected to the PC terminal 200 transmits to acknowledge the receipt of the ID code data. Here, FIGS. 7(a) and 7(b) show the case where the data transmit timing is proceeding normally.

As shown in FIGS. 7(a) and 7(b), the ID code data is transmitted from the portable device 100 at predetermined intervals of time (every two seconds) and, in response to this, the ACK signal is transmitted at predetermined intervals of time (every two seconds) from the second transmitting/receiving section 254 of the base 250 connected to the PC terminal 200.

Part (c) shows the transmit timing of the ID code data transmitted from the portable device 100, and part (d) shows the transmit timing of the ACK signal transmitted from the base 250. FIGS. 7(c) and 7(d) show an example of a measure taken in the event of occurrence of abnormality in the data transmit timing. That is, FIGS. 7(c) and 7(d) show the condition where ACK signals 702 and 704 that would normally be transmitted from the base 250 in response to the ID code data transmitted at times 701 and 703 from the portable device 100 are not received at the portable device 100.

The ID code data and the ACK signal are exchanged between the portable device 100 and the PC terminal 200 over a wireless link but, because of the nature of wireless transmissions, there can occur cases where the wireless communication is abruptly interrupted, as shown in FIGS. 7(c) and 7(d). If the PC terminal 200 is locked due to the interruption of the communication while the user carrying the portable device 100 is staying in the vicinity of the PC terminal. 200, the user will feel that the predetermined interval (two seconds) elapsing until re-authentication is very long. In view of this, when the communication is interrupted, it is preferable to shorten the transmission interval thereby shortening the time interval that elapses until the PC terminal 200 is unlocked again.

Therefore, in the example of FIG. 7(c), when the ACK signal that would normally be received is not received, the first control section 101 of the portable device 100 performs control to shorten the time interval (from two seconds to one second) at which to transmit the ID code data next. When the ACK signal that should be received is normally received, the normal time interval (two seconds) is resumed.

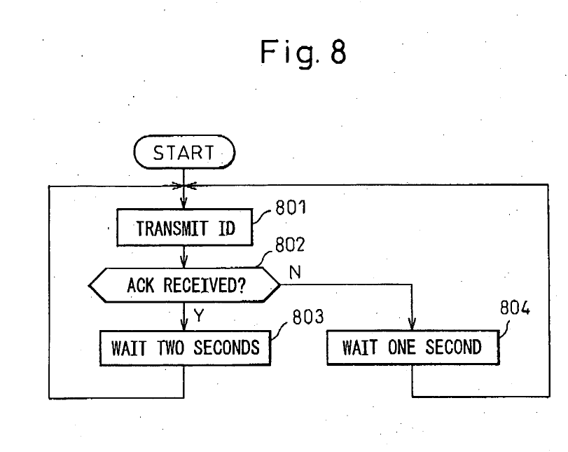

FIG. 8 is a diagram showing one example of a control flow for controlling the data transmit timing shown in FIGS. 7(c) and 7(d).

In FIG. 8, the first control section 101 of the portable device 100 transmits the ID code by using the first transmitting/receiving section 105 (S801), and determines whether an ACK signal is received within a predetermined fraction of time after that (S802). When the ACK signal is received, the process waits two seconds as usual (S803), and then the ID code is transmitted (S801); on the other hand, if the ACK signal is not received, control is performed to wait one second (S804) and then transmit the ID code (S801).

Part (e) shows the transmit timing of the ID code data transmitted from the portable device 100, and part (f) shows the transmit timing of the ACK signal transmitted from the base 250. FIGS. 7(e) and 7(f) show another example of the measure taken in the event of occurrence of abnormality in the data transmit timing. That is, FIGS. 7(e) and 7(f) show the condition where ACK signals 712, 714, and 716 that would normally be transmitted from the base 250 in response to the ID code data transmitted at times 711, 713, and 715 from the portable device 100 are not received at the portable device 100.

In the case shown in FIGS. 7(e) and 7(f) also, if the PC terminal 200 is locked due to the interruption of the communication while the user carrying the portable device 100 is staying in the vicinity of the PC terminal 200, the user will feel the predetermined interval (two seconds) elapsing until re-authentication is very long. In view of this, when the communication is interrupted, control is performed so that the transmission interval is shortened first and, if the ACK signal still cannot be received, the transmission interval is gradually set back to its original value. That is, if the ACK signal cannot be received even when the transmission interval is shortened, there is the possibility that the communication has not been interrupted while the user is around the PC terminal 200, but has been interrupted because the user has moved away from the PC terminal 200; in view of this, the time interval that elapses until the PC terminal is unlocked again is adjusted as described above.

In the example of FIG. 7(e), when the ACK signal that would normally be received is not received, the first control section 101 of the portable device 100 performs control so that the time interval at which to transmit the ID data next is first shortened to one second and then increased to 1.5 seconds and finally to two seconds. When the ACK signal that should be received is normally received, the normal time interval (two seconds) is resumed. If the transmission interval is kept short for an extended period of time as shown in FIG. 7(c), the battery in the power supply of the portable device 100 may be exhausted quickly; therefore, control is perform to gradually increase the transmission interval after once shortening it.

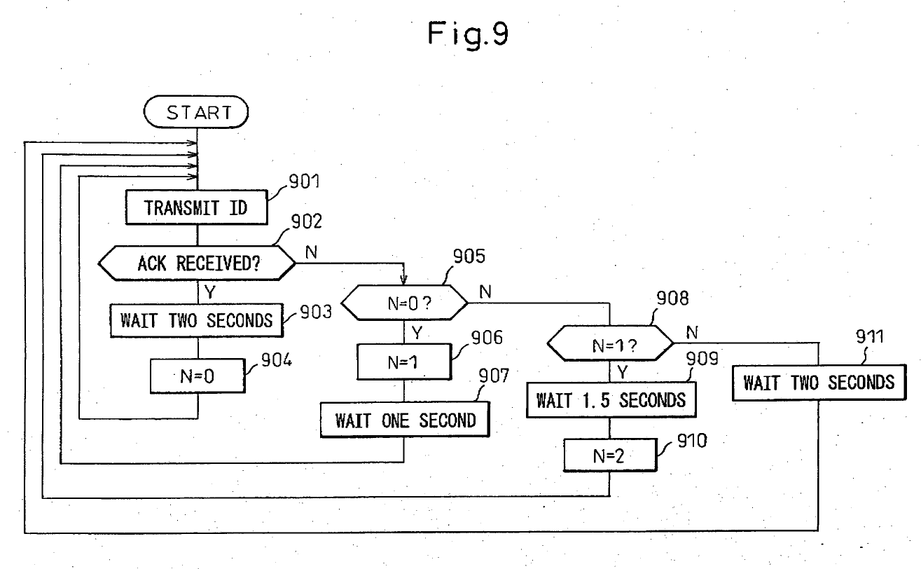

FIG. 9 is a diagram showing one example of a control flow for controlling the data transmit timing shown in FIGS. 7(e) and 7(f).

The first control section 101 of the portable device 100 transmits the ID code by using the first transmitting/receiving section 105 (S901), and determines whether an ACK signal is received within a predetermined fraction of time after that (S902). When the ACK signal is received, the process waits two seconds as usual (S903) and, after setting N=0 (S904), the ID code is transmitted (S901). If the ACK signal is not received in S902, it is determined whether N=0 or not (S905); if N=0, then N is set to 1 (S906) and, after waiting one second (S907), the ID code is transmitted (S901).

On the other hand, if N is not equal to 0 in S905, then it is determined wither N=1 or not (S908); if N=1, the process waits 1.5 seconds (S909) and, after setting N=2 (S910), the ID code is transmitted (S901). If N is not equal to 1 in S908, the process waits two seconds (S911), and then the ID code is transmitted (S901).

In this way, if the ACK signal cannot be received at the portable device 100, control is performed to shorten the ID code transmission interval thereby shortening the time interval that elapses until the PC terminal 200 is unlocked by re-authentication. Further, when the ACK signal cannot be received at the portable device 100, if the transmission interval is kept short for an extended period of time, the battery life of the power supply of the portable device 100 will become shorter; therefore, control is perform to gradually increase the transmission interval back to the normal interval after once shortening it. The normal transmission interval (two seconds) and the shortened time intervals (1 second and 1.5 seconds) shown in FIGS. 7(c) to 7(f) and FIGS. 8 and 9 are for illustrative purposes only, and various modifications may be made according to the application.

In the examples of FIGS. 7(a) to 7(f), signals are exchanged between the portable device 100 and the PC terminal 200, but the ACK signal to be transmitted from the PC terminal 200 to the portable device 100 need not necessarily be used. In particular, in cases where the control shown in FIGS. 7(c) to 7(f) is not performed, the portable device 100 need not receive the ACK signal from the PC terminal 200. That is, signals may be transmitted only in one direction from the portable device 100 to the PC terminal 200. In that case, the first transmitting/receiving section 105 need only be equipped with a transmitting function, and the second transmitting/receiving section 254 need only be equipped with a receiving function.

Next, a description will be given of a method for automatically locking the PC terminal 200 when the user has left the PC terminal 200 while leaving the portable device 100 in its vicinity.

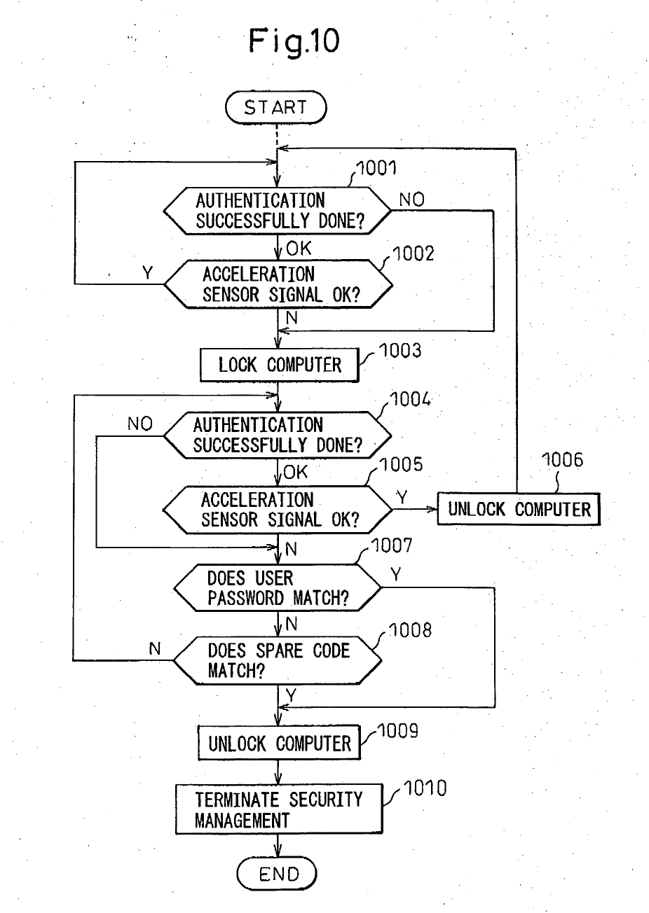

FIG. 10 is a diagram showing another example of the control flow of the locking system according to the present invention.

In the control flow of FIG. 10, it is determined whether the portable device 100 is moving or not, by using a signal from the acceleration sensor 106 contained in the portable device 100. In the control flow of FIG. 10, if the portable device 100 has remained stationary for a predetermined period of time, the PC terminal 200 is automatically locked by determining that the portable device 100 has been left alone.

The control flow shown in FIG. 10 is constructed to be executed primarily by the second control section 201 in accordance with the locking system application program preinstalled in the second storage section 203 of the PC terminal 200. The first half of the flow of FIG. 10 is the same as that of the control flow of FIG. 3 (S301 to S309) and, therefore, is not shown here. Further, in the control flow of FIG. 10, the portable device 100 which is equipped with the acceleration sensor is constructed to transmit the output signal (detection result) of the acceleration sensor together with the ID code data at predetermined intervals of time. Here, the output signal of the acceleration sensor and the ID code data may be transmitted simultaneously or at different times.

When the authentication IDs match in S307 in FIG. 3, the second control section 201 performs the authentication process shown in FIG. 4 (S1001) at predetermined intervals of time (for example, every two seconds). When the authentication is successfully done, the control section 201 then determines whether the signal from the acceleration sensor 106 satisfies a predetermined condition (S1002). When the authentication is successfully done in S1001, and when the signal from the acceleration sensor 106 satisfies the predetermined condition in S1002, the control section 201 repeats the execution of the authentication process and the checking of the signal from the acceleration sensor 106 at predetermined intervals of time (for example, every two seconds) while keeping the PC terminal 200 enabled for use. On the other hand, when the authentication is successfully done in S1001, but the signal from the acceleration sensor 106 does not satisfy the predetermined condition in S1002, the control section 201 locks the PC terminal 200 (S1003).

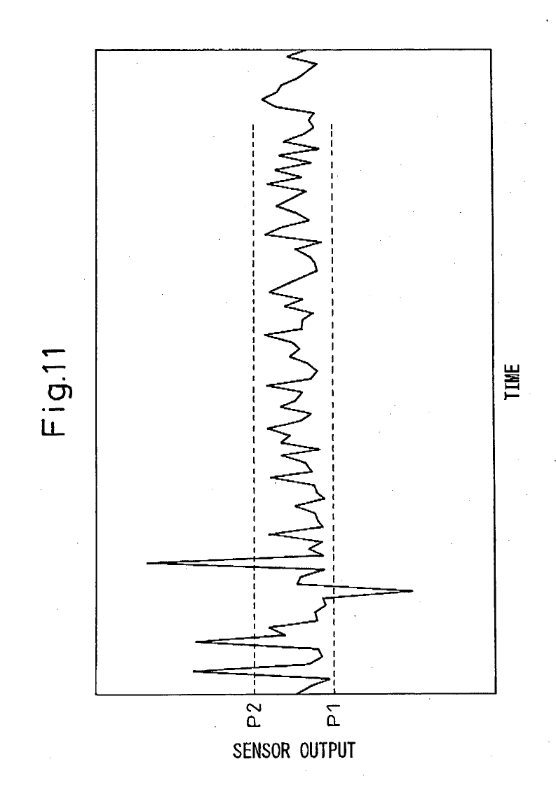

FIG. 11 is a diagram showing one example of the signal output from the acceleration sensor 106.

In FIG. 11, the time is plotted along the abscissa and the sensor output (voltage value) along the ordinate. In the figure, P1 and P2 are values obtained from empirical values; when the portable device 100 is worn on the user, signal values not larger than P1 or not smaller than P2 are output. On the other hand, when the portable device 100 is left stationary on a desk or the like, signal values larger than P1 but smaller than P2 are continually output. Accordingly, in the present embodiment, when a signal value not larger than P1 or not smaller than P2 is output, it is determined that the predetermined condition is satisfied.

Once the PC terminal 200 has been locked, the PC terminal 200 will not be unlocked for use again, unless one of the following conditions is satisfied: the authentication is successfully done in the subsequent cycle of the authentication process (S1004) and the signal from the acceleration sensor 106 satisfies the predetermined condition (S1005); the correct user password is entered (S1007); and the correct spare code is entered (S1008). That is, as long as none of these conditions are satisfied, the PC terminal 200 will remain locked, and therefore, cannot be used.

Here, when the authentication is successfully done in the subsequent cycle of the authentication process, and the signal from the acceleration sensor 106 satisfies the predetermined condition, the PC terminal 200 is unlocked (S106), and the process returns to S1001 to continue the security management of the PC terminal 200 as usual; on the other hand, in the case where the correct user password is entered (S1007) or where the correct spare code is entered (S1008), the security management is terminated (S1010) after unlocking the PC terminal 200 (S1009).

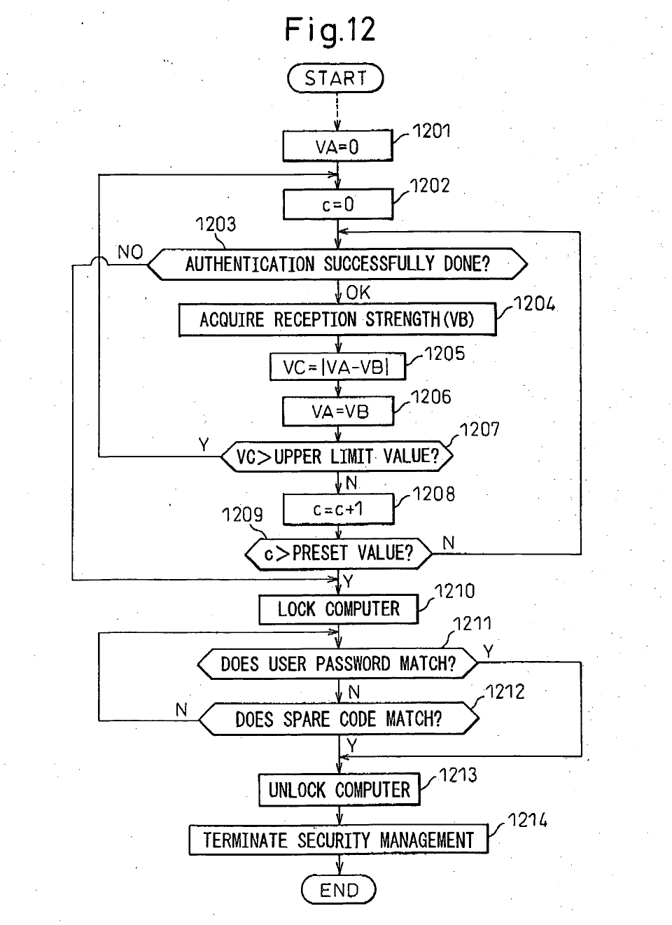

FIG. 12 is a diagram showing still another example of the control flow of the locking system according to the present invention.

In the control flow shown in FIG. 12, it is determined whether the portable device 100 is moving or not, by using the reception strength detector 255 contained in the base 250. In the control flow shown in FIG. 12, if the portable device 100 has remained stationary for a predetermined period of time, the PC terminal 200 is automatically locked by determining that the portable device 100 has been left alone.

The control flow shown in FIG. 12 is constructed to be executed primarily by the second control section 201 in accordance with the locking system application program preinstalled in the second storage section 203 of the PC terminal 200. The first half of the flow of FIG. 12 is the same as that of the control flow of FIG. 3 (S301 to S309), and therefore is not shown here. Further, in the control flow of FIG. 12, the second transmitting/receiving section 254 of the base 250 is constructed by including the reception strength detector 255, and the control section 201 is constructed to be able to receive the reception strength from the reception strength detector 255.

First, the control section 201 sets VA (previous reception strength)=0 (S1201) and c (stable reception strength detection count)=0 (S1202). Reception strength (VB) is data initially detected as voltage value data and then A/D converted and normalized with respect to a reference value.

When the authentication IDs match in S307 in FIG. 3, the second control section 201 performs the authentication process shown in FIG. 4 (S1203) at predetermined intervals of time (for example, every two seconds). When the authentication is successfully done, the control section 201 then acquires from the reception strength detector 255 the reception strength (VB) detected when the base 250 received the authentication ID (Sl204).

Next, the second control section 201 obtains the absolute value VC of the difference between the previous reception strength and the present reception strength (S1205), and sets the present reception strength (VB) as VA (S1206) which is used for comparison in the next cycle of the process.

Then, the second control section 201 determines whether VC is larger than a predetermined upper value (S1207). When the value of VC is larger than the predetermined upper value, that is, when the difference from the previous reception strength is larger than the predetermined value, then it can be determined that the reception strength has changed due to the movement of the portable device 100. Here, the upper value can be determined by experiment.

Next, the second control section 201 sets c=c+1 (S1208), and determines whether c is larger than a preset value (for example, 3600) (Sl209). If, in S1209, c is larger than the preset value, the second control section 201 locks the PC terminal 200 (S1210). That is, control is performed so that when VC is determined to be smaller than the predetermined value for the preset number of times in succession, it is determined that the portable device 100 is not worn on the user but is left alone.

Once the PC terminal 200 has been locked, the PC terminal 200 will not be unlocked for use again, unless either one of the following two conditions is satisfied: the correct user password is entered (S1211); and the correct spare code is entered (S1212). That is, as long as neither condition is satisfied, the PC terminal 200 will remain locked, and therefore, cannot be used.

In the case where the correct user password is entered (S1211) or where the correct spare code is entered (S1212), the security management is terminated (S1214) after unlocking the PC terminal 200 (S1213). Here, as previously explained with reference to S1004 in the control flow of FIG. 10 (the example that uses the acceleration sensor), provisions may be made so that the PC 200, once locked, can be unlocked in the subsequent cycle of the authentication process.

As described above, in the control flow shown in FIG. 10, in addition to the authentication process (refer to FIG. 4) provisions are made to be able to check, based on the signal from the acceleration sensor 106, as to whether or not the portable device 100 is worn on the user. Further, in the control flow shown in FIG. 12, in addition to the authentication process (refer to FIG. 4) provisions are made to be able to check, based on the reception strength from the reception strength detector 255, as to whether or not the portable device 100 is worn on the user. In this way, as the control is performed based on the data for recognizing whether or not the portable device 100 is worn on the user, security can be enhanced by forcefully locking the PC terminal 200 in a case such as when the portable device 100 is left alone near the PC terminal 200.

Further, in the control flows described with reference to FIGS. 10 to 12, in addition to performing the usual authentication process, control is performed so that the PC terminal is locked depending on the detection of an event indicating that the portable device 100 is not worn on the user. However, control may be preformed so that when, in addition to the detection of the above event, it is also detected that no data inputs have been made from the second operation section 204 (mouse, keyboard, etc.) of the PC terminal 200, the PC terminal 200 is then locked. The fact that the user is performing some data entry operation from the second operation section 204 means that the user is near the PC terminal 200; therefore, even when the portable device 100 is not worn on the user, the PC terminal 200 should be kept unlocked for use.

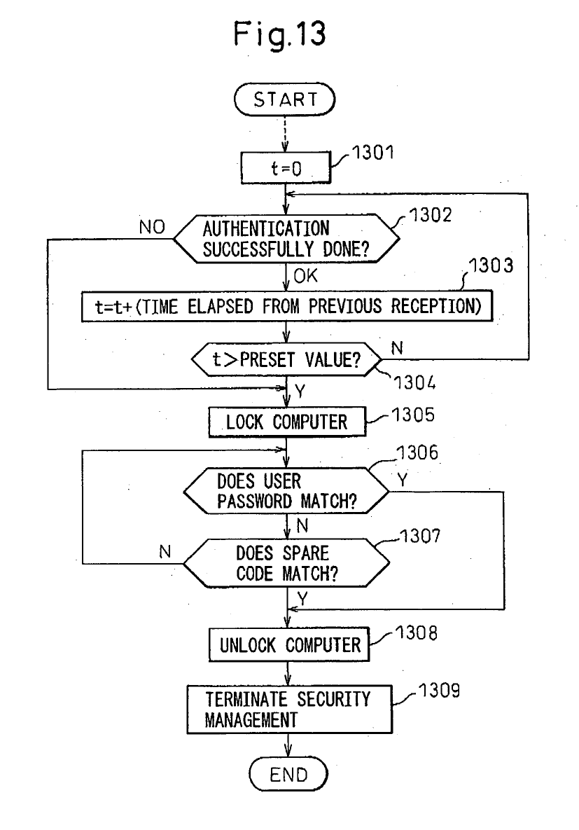

FIG. 13 is a diagram showing yet another example of the control flow of the locking system according to the present invention.

In the control flow shown in FIG. 13, a forceful termination time preset by the user (for example, eight hours) is counted, and when the forceful termination time has elapsed, the PC terminal 200 is automatically locked.

The control flow shown in FIG. 13 is constructed to be executed primarily by the second control section 201 in accordance with the locking system application program preinstalled in the second storage section 203 of the PC terminal 200. The first half of the flow of FIG. 13 is the same as that of the control flow of FIG. 3 (S301 to S309), and therefore is not shown here.

First, the second control section 201 sets t=0 (S1301), and performs the authentication process shown in FIG. 4 (S1302). When the authentication is successfully done, the control section 201 then sets t=t+(time elapsed from the previous reception) (S1303), and determines whether t is larger than a preset value (for example, eight hours) (S1304)

If, in S1304, t is larger than the preset value, the second control section 201 forcefully locks the PC terminal 200 (S1305).

Once the PC terminal 200 has been locked, the PC terminal 200 will not be unlocked for use again, unless either one of the following two conditions is satisfied: the correct user password is entered. (S1306); and the correct spare code is entered (S1307). That is, as long as neither condition is satisfied, the PC terminal 200 will remain locked, and therefore, cannot be used. Here, as previously explained with reference to S1004 in the control flow of FIG. 10 (the example that uses the acceleration sensor), provisions may be made so that the PC 200, once locked, can be unlocked in the subsequent cycle of the authentication process.

In the case where the correct user password is entered (S1306) or where the correct spare code is entered (S1307), the security management is terminated (S1309) after unlocking the PC terminal 200 (Sl308).

As described above, in the control flow shown in FIG. 13, in addition to performing the usual authentication process (refer to FIG. 4), control is performed so that the PC terminal is forcefully locked when the forceful termination time has elapsed; this serves to enhance security.

What is claimed is:

1. A locking system comprising:
a portable device having a public code comprising,
first storage means for storing a first authentication code,
a first control section for generating a rolling value and for creating an ID code by using said rolling value and said first authentication code, and
transmitting means for transmitting said ID code;
a management server for managing said computer; and
a computer comprises,
second storage means for storing a second authentication code,
receiving means for receiving said ID code, and
second control means for recovering said rolling value and said first authentication code from said ID code, creating a spare code by using said second authentication code and said recovered rolling value, and storing said spare code, and wherein
said second control means unlocks said computer when said recovered first authentication code matches said second authentication code, but locks said computer when said recovered first authentication code does not match said second authentication code,
when said computer has been locked, said second control means unlocks said computer when a code that matches said spare code is input, and
said second control means creates a rolling code using said public code and said rolling value in order to acquire said code that matches said spare code from said computer management server.

2. The locking system according to claim 1, said computer management server comprising:
a database constructed by associating each public code with a corresponding authentication code;
receiving means for receiving said rolling code; and
third control means for recovering said public code and said rolling value from said rolling code, searching said database to retrieve said corresponding authentication code associated with said recovered public code, and creating a second spare code from said recovered rolling value and said retrieved authentication code.

3. The locking system according to claim 1, wherein said portable device further comprises encrypting means for encrypting said ID code, and
said computer further comprises decrypting means for decrypting said ID code received in encrypted form.

4. The locking system according to claim 1, wherein said computer further comprises encrypting means for encrypting said rolling code and decrypting means for decrypting said spare code input thereto, and
said computer management server further comprises decrypting means for decrypting said rolling code and encrypting means for encrypting said second spare code.

5. The locking system according to claim 1, wherein said second control means creates said spare code by using said rolling value initially received from said portable device.

6. The locking system according to claim 1, wherein said computer further comprises storing means for storing the most up-to-date rolling value received from said portable device, and
said second control means performs control so that said computer is locked when the currently acquired rolling value does not change from the most up-to-date rolling value stored in said storage means.

7. The locking system according to claim 1, wherein said second control means sets a user password and stores said user password, and when said computer has been locked, said second control means unlocks said computer when a code that matches said user password is input.

8. A locking method for locking a computer, comprising the steps of;
receiving, from a portable device having a public code, an ID code that said portable device created by using a rolling value generated by said portable device and a first authentication code prestored in said portable device;
recovering said rolling value and said authentication code from said ID code;
creating a first spare code from said rolling value recovered from said ID code and a second authentication code prestored in said computer, and storing said first spare code:
locking said computer when said first authentication code recovered from said ID code does not match said second authentication code;
creating a rolling code from said public code and said rolling value recovered from said ID code;
receiving a spare code that a management server for managing said computer created from said rolling value recovered from said rolling code and said second authentication code retrieved by conducting a search based on said public code recovered from said rolling code; and
unlocking said computer when said received spare code matches said first spare code.

9. A locking system includes an apparatus to be locked and an identification information transmitter for transmitting first identification information,
said apparatus to be locked comprising:
a control section which performs a first authentication process using said first identification information received from said identification information transmitter and a second authentication process using second identification information other than said received first identification information, controls said apparatus, to be unlocked when authentication is successfully done in said first or second authentication process, and creates spare identification information with which said second identification information is compared in said second authentication process.

10. The locking system according to claim 9, wherein said control section creates said spare identification information by using said received first identification information.

11. The locking system according to claim 9, wherein said first identification information includes variable identification information which varies each time said first identification information is transmitted from said identification information transmitter, and
said control section creates said spare identification information by using said variable identification information.

12. The locking system according to claim 9, wherein said first identification information includes unique identification information unique to said identification information transmitter and variable identification information which varies each time said first identification information is transmitted from said identification information transmitter, and
said control section creates said spare identification information by using said unique identification information and said variable identification information.

13. The locking system according to claim 12, wherein said unique identification information includes first fixed identification information and second fixed identification information, and
said first authentication process is a process in which, when said first fixed identification information matches data stored in said locked apparatus, then a determination is made as to whether said second fixed identification information and said variable identification information satisfy a prescribed condition.
